(19) United States
(12) Patent Application Publication
(10) Pub. No.: US 2005/0172535 A1
(43) Pub. Date: Aug. 11, 2005

(54) Line guide for fishing rods

(76) Inventor: Tsung-Seng Lee, Tainan City (TW)

Correspondence Address: BIRCH STEWART KOLASCH & BIRCH, PO BOX 747, FALLS CHURCH, VA, 22040-0747, US

(21) Appl. No.: 10/772,357

(22) Filed: Feb. 6, 2004

(51) Int. Cl. A01K 87/04

(52) U.S. Cl. 43/24

(57) ABSTRACT

An improved line guide for fishing rods includes a circular ring at one end. The perimeter of the circular ring has two opposite sides extended respectively downwards to form a vertical section. The vertical section has a distal end extended slightly outwards and downwards and bent inwards to become narrower to form an inclined conical section with a horizontal plane at one end. The two horizontal planes are symmetrical and joined juxtaposed to form a flat and conical fastening section. The circular ring further has a lower side extended downwards to form an arrow-shaped fastening section. The inclined conical section has a vertical surface to form surface contact with a fishing line. The inclined conical section can increase the strength of the line guide and prevent the line guide from deforming when subject to stress or impact from external forces.

### FIELD OF THE INVENTION

The present invention relates to an improved line guide for fishing rods and particularly to a line guide that is sturdy and may be fabricated at a lower cost and can prevent tangling of the fishing line.

### BACKGROUND OF THE INVENTION

The conventional line guide for fishing rods (referring to FIGS. 1 and 2) generally has two arms extended downwards from two sides of a circular ring and bent outwards horizontally to form two curved conical flanks. The conical flanks are joined together at the respective distal ends to form a symmetrical flat fastening section. The circular ring further has a lower side extended to form a second flank and bent outwards to form an arrow-shaped fastening section opposite to the flat fastening section. The flat fastening section and the arrow-shaped fastening section are fastened to a fishing rod at a desired location by winding a thread. Such a construction has drawbacks when in use, notably:

1. The fishing line can sway under external forces, resulting in uneven tension. If the fishing line is not withdrawn in a timely manner, it is prone to tangle with the line guide when the fishing rod is moved to cast or withdraw the fishing line.

2. The conventional circular ring is not strong enough and can easily bend or deform when subject to stress or impact of an external force (referring to FIG. 2), it can even become nonfunctional.

3. The curved conical flanks of the line guide have a narrower lower section while the upper section connecting to the circular ring is wider (referring to FIG. 3). The fishing line tends to tangle with the line guide when the tension of the line is uneven. The tangled fishing line generally is located at the upper section above the horizontal cross section to form a point contact. This often causes the fishing line to slip into the opening of the circular ring and catch on the line guide. As a result, it is difficult to withdraw the fishing line as desired.

### SUMMARY OF THE INVENTION

In view of the foregoing disadvantages, the primary object of the present invention is to resolve the problems occurring with conventional line guides of fishing rods. The invention provides an improved line guide that is sturdy and may be fabricated at a lower cost, and also can avoid tangling with the fishing line.

The line guide according to the invention has a circular ring on one end. The perimeter of the circular ring has two opposite sides extended downwards respectively to form a vertical section. The vertical section has a distal end extended slightly outwards and bent gradually inwards to form an inclined conical section. The line guide thus formed is stronger and can better withstand stretching and impact of external forces without deforming, and also can prevent tangling of the fishing line.

Another object of the invention is to provide a line guide that has a pair of inclined conical sections to form respectively a similar arched edge on the upper side and a lower side so that the fishing line may be wound securely without becoming caught or tangled.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional line guide for fishing rods.

FIG. 2 is a schematic view of a deformed line guide according to FIG. 1.

FIG. 3 is a top view of FIG. 1.

FIG. 4 is a perspective view of the invention.

FIG. 5 is a top view of the invention.

FIG. 6A is a side view of the invention.

FIG. 6B is a cross section taken on line 6B-6B in FIG. 6A.

FIG. 7 is a schematic view of the invention without threading with a fishing line.

FIG. 8 is a schematic view of the invention threaded with a fishing line.

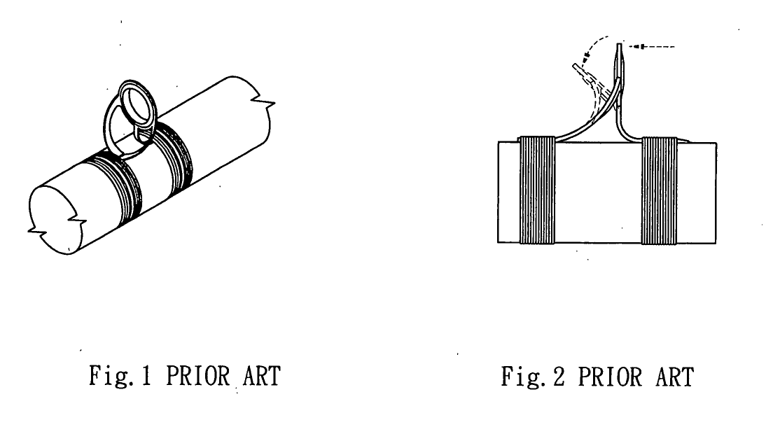

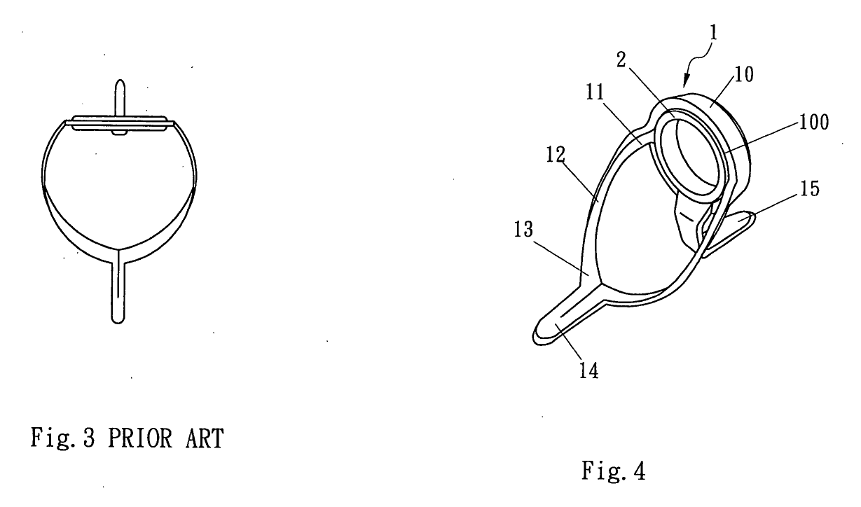

### DETAILED DESCRIPTION OF THE PREFERRED EMBODIMENT

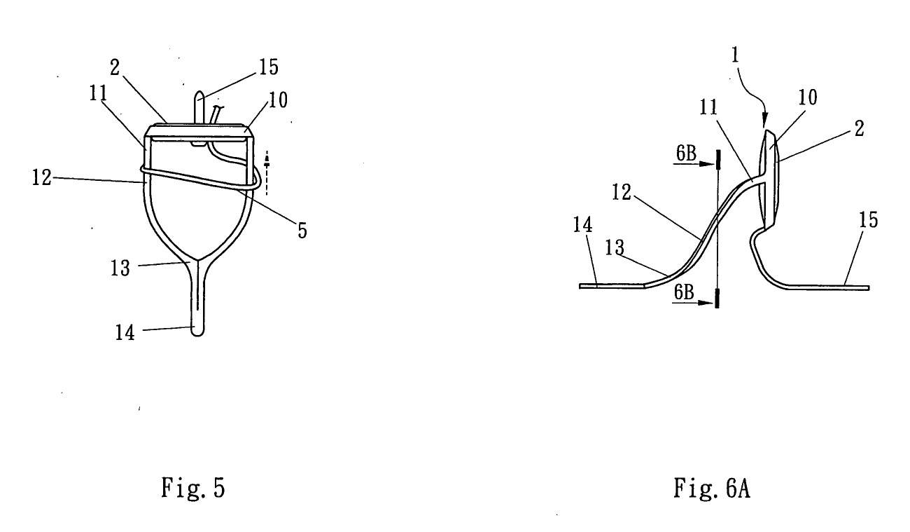

Referring to FIGS. 4 and 5; the improved line guide according to the invention includes a line guide seat 1 and a ceramic ring 2. The line guide seat 1 has a circular ring 10 at one end. Two opposite sides of the perimeter of the circular ring 10 are extended downwards to form respectively a vertical section 11. The vertical section 11 has a distal end extended slightly downwards and bent inwards to become an inclined conical section 12 and form a narrower horizontal plane 13 at the juncture. Such a structure can increase the strength of the line guide seat 1, and prevent the line guide seat 1 from deforming when subject to stress or impact from an external force, it also prevents the fishing line 5 from entangling.

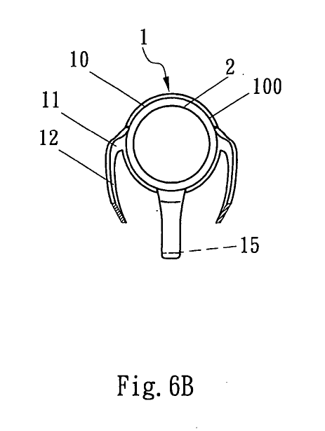

The horizontal plane 13 formed by extending the inclined conical section 12 is symmetrical to the one extended from another inclined conical section 12. The two symmetrical horizontal planes 13 are joined juxtaposed to become a flat and conical fastening section 14. The circular ring 10 of the line guide seat 1 further has a lower side extended downwards to form an arrow-shaped fastening section 15 opposite to the conical fastening section 14 (referring to FIGS. 6A and 6B).

The ceramic ring 2 is circular and wedged in an opening 100 of the circular ring 10 of the line guide seat 1.

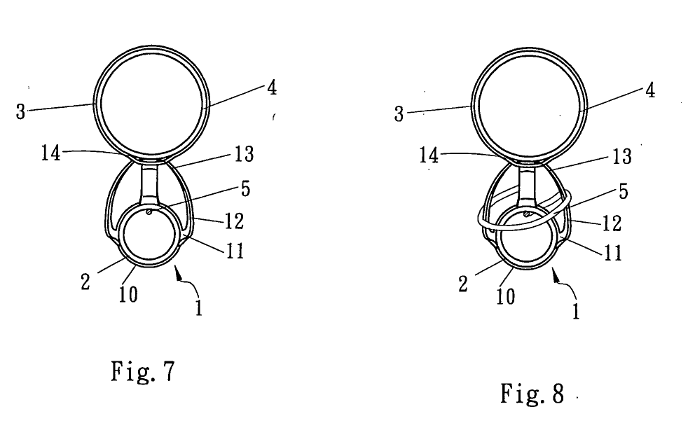

Referring to FIG. 7, after the ceramic ring 2 has been coupled with the circular ring 10, the line guide seat 1 may be fastened to a fishing rod 4 at a desired location by winding a thread 3 around the conical and arrow-shaped sections 14 and 15 against the fishing rod 4. As the fishing line 5 tends to sway under external forces when the fishing rod 4 is moved to cast or withdraw the fishing line, and the tension of the fishing line 5 becomes uneven and might affect fish catching. To remedy this problem, the line guide seat 1 has two vertical sections 11 extended downwards from two opposite sides of the perimeter of the circular ring 10 and further extended slightly outwards and downwards to form a narrower inclined conical section 12 to form a surface contact with the fishing line 5 and wind the fishing line 5 (as shown in FIG. 8). The line guide seat 1 thus constructed is stronger and the fishing line 5 does not sway or entangled.

1. A line guide for fishing rods comprising a circular ring on one end; the circular ring having a top, a bottom and two opposite sides, each of the two sides of the perimeter extending downwards to form a vertical section; the two sides extending from the sides of the circular ring below the top of the ring; the vertical section having a distal end extended outwards and downwards and bent inwards to become narrower so as to form an inclined conical section which has a horizontal plane at one end; the horizontal planes of two sides being symmetrical and joined juxtaposed to form a flat and conical fastening section; the circular ring further having a lower end extended downwards from the bottom of the ring to form an arrow-shaped fastening section opposite to the conical fastening section.

2. The line guide of claim 1, wherein the inclined conical section has a vertical surface to form a surface contact with the fishing line.
